(19) United States
(12) Patent Application Publication
(10) Pub. No.: US 2003/0144937 A1
(43) Pub. Date: Jul. 31, 2003

(54) Method for funding initiatives under the community reinvestment act

(76) Inventors: Glenn C. Garella, Charlotte, NC (US); Roger Pell, Charlotte, NC (US)

Correspondence Address: Schwartz Law Firm, P. C., 6100 Fairview Road, suite 530, Charlotte, NC, 28210, US

(21) Appl. No.: 10/058,394

(22) Filed: Jan. 28, 2002

(51) Int. Cl. G06F 17/60

(52) U.S. Cl. 705/36

(57) ABSTRACT

A method is provided for funding initiatives under the Community Reinvestment Act (CRA). The method includes the step of lending funds to an administrative foundation serving to promote financial opportunities and services to targeted neighborhood communities. The funds are used to purchase life insurance policies for selected affiliates of the foundation. The loan to the foundation is collateralized using a cash value of the life insurance policies purchased by the foundation. Upon receipt of death benefits from the policies, a first portion of the benefits is applied to repay the funds loaned to the foundation, and a second portion of the benefits applied to the foundation to fund designated CRA initiatives.

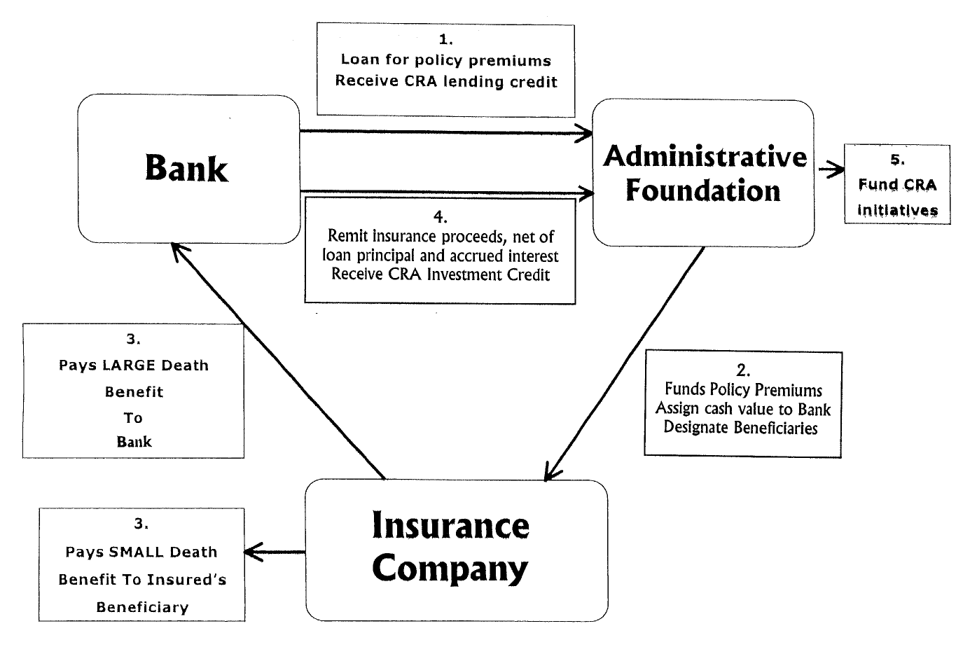

### TECHNICAL FIELD AND BACKGROUND OF INVENTION

This application relates to a method for funding initiatives under the Community Reinvestment Act (CRA). The invention utilizes a bank loan collateralized through life insurance policies issued on the lives of selected affiliates of a non-profit administrative foundation, such as that chartered by the National Community Reinvestment Coalition (NCRC). The foundation is responsible for developing and promoting initiatives designed to gain credit opportunities and the provision of banking services in traditionally underserved neighborhood communities.

The CRA was passed by Congress in 1977. According to the act, regulated financial institutions have “continuing and affirmative obligations to help meet the credit needs of the local communities in which they are chartered.” As a policing authority, the act established regulatory agencies for monitoring and grading banks on their level of lending, investment, and services in low- and moderate-income neighborhoods. The federal agencies conducting CRA examinations include the Office of the Comptroller of the Currency that examines nationally chartered banks, the Office of Thrift Supervision that examines savings and loan institutions, and the Federal Deposit Insurance Corporation and the Federal Reserve Board, both of which examine state chartered banks.

If a regulatory agency determines through its examination that a lending institution is not adequately serving the targeted neighborhoods, it can delay or deny that institution's request to merge with another lender or to open a branch or expand any of its other services. The regulatory agency can also approve the merger application subject to specific improvements in a bank's lending or investment record in low- and moderate-income neighborhoods.

Current CRA regulations establish three different tests for lending institutions and a strategic plan option. Under each test, examiners rate banks according to their lending records and responsiveness to community needs. Banks receive a score based on their evaluations of “outstanding”, “satisfactory”, “needs to improve”, or “substantial noncompliance.” The last two scores can result in delays or denials of mergers, acquisitions, or expansions of services.

Lending institutions with assets greater than $250 million are subjected to the most rigorous exams. They are evaluated based on lending, investment and financial services to low and moderate-income individuals and communities. When conducting the evaluations, examiners consider the “performance context” of the lending institutions. In other words, examiners are advised to consider factors such as the business opportunities available to a lending institution and the size and financial condition of the lending institution.

Small banks are defined as institutions with less than $250 million in assets. These banks are evaluated under a less rigorous, “streamlined” exam which excludes investment and service tests. Their lending test consists of the following five criteria: a “reasonable” loan-to-deposit ratio, the percentage of loans in the bank's assessment area, the bank's distribution of loans to individuals of different income levels and businesses and farms of different sizes, the geographic distribution of loans, and the bank's record of responding to written complaints about its lending performance in its assessment area.

A less frequent exam cycle is provided for small banks with passing CRA ratings. Small banks with outstanding ratings are examined once every five years and those with satisfactory ratings are examined once every four years. More frequent examinations may be made if deemed necessary by the regulatory agencies. In addition, community groups may contact the regulatory agencies directly if they believe that a particular small bank should be examined before its lengthened time cycle.

Wholesale and limited purpose banks are also evaluated by the regulatory agencies based on criteria specific to their particular services. These banks generally provide services such as offering credit cards or specialize in large commercial deposits. Lending tests cannot adequately assess wholesale and limited purpose banks because many of them do not accept small deposits or make home loans. Instead examiners focus their evaluation of these banks on the number of community development loans and investments, such as affordable housing rehabilitation loans, low-income housing tax credits, or investments in organizations that finance small businesses. The tests for big banks also consider community development loans and investments.

Any lending institution can opt for developing a strategic plan in lieu of a regulator evaluation. Developed in conjunction with neighborhood organizations, a strategic plan seeks to satisfy the credit needs of a bank's assessment area and must address the lending, investment, and service criteria that would have been part of the usual evaluation. Federal regulators must approve the strategic plan and rate it at least “satisfactory.” If a bank receives a lower rating on its plan, it has the option of submitting to the applicable tests for large, small, or limited purpose banks.

In addition to the strategic plan option, community groups can be involved in the CRA evaluation process. Federal agencies publish in advance a list of banks that will be evaluated each quarter. Once every three months, the NCRC notifies its members about the banks scheduled for upcoming CRA exams. The NCRC encourages its members and other neighborhood organizations to offer their comments on the CRA performance of banks in advance of their examinations. Such comments can have a strong influence on a bank's CRA rating by directing examiners to particular areas of strength or weakness in a bank's lending, investments, or services in low- and moderate-income neighborhoods.

The practical problem realized by banks in their efforts to meet CRA performance requirements is that a relatively high percentage of loans made to targeted individuals and businesses result in default. Nevertheless, in order to maintain a satisfactory CRA rating, banks are obliged to assume the risk of non-payment. Since these loans are generally unsecured, the banks must bear a considerable financial burden which creates a reluctancy to support community reinvestment initiatives prescribed by the act.

The present invention addresses this and other issues concerning CRA funding. The invention provides a method for collateralizing bank loans to support CRA initiatives while generating long-term, predictable funding for community development. The invention minimizes the credit risk to the participating financial institution while obtaining favorable consideration under the provisions of the CRA.

### SUMMARY OF INVENTION

Therefore, it is an object of the invention to provide a method for funding initiatives under the Community Reinvestment Act (CRA) which minimizes the credit risk to the participating financial institution.

It is another object of the invention to provide a method for funding initiatives under the CRA which generates long-term, predictable funding for community development.

It is another object of the invention to provide a method for funding initiatives under the CRA which creates positive public relations exposure for the and participating financial institution.

It is another object of the invention to provide a method for funding initiatives under the CRA which generates a pool of funds that is not subject to safety and soundness considerations of the lending institution.

It is another object of the invention to provide a method for funding initiatives under the CRA wherein the participating financial institution receives CRA credit for the lending, investment, and service tests.

It is another object of the invention to provide a method for funding initiatives under the CRA wherein the participating financial institution receives a competitive return on funds loaned to the foundation.

It is another object of the invention to provide a method for funding initiatives under the CRA which provides free life insurance for selected CRA affiliates.

It is another object of the invention to provide a method for funding initiatives under the CRA which offers a significant wealth building opportunity for low- to moderate-income neighborhoods through death benefits paid to insured CRA affiliates.

It is another object of the invention to provide a method for funding initiatives under the CRA which offers minimal restrictions on lending and investment activities.

These and other objects of the present invention are achieved in the preferred embodiments disclosed below by providing a method for funding initiatives under the Community Reinvestment Act (CRA). The method includes the step of lending funds to an administrative foundation serving to promote financial opportunities and services to targeted neighborhood communities. The funds are used to purchase life insurance policies for selected affiliates of the foundation. The loan to the foundation is collateralized using a cash value of the life insurance policies purchased by the foundation. Upon receipt of death benefits from the policies, a first portion of the benefits is applied to repay the funds loaned to the foundation, and a second portion of the benefits applied to the foundation to fund designated CRA initiatives.

According to another preferred embodiment of the invention, the administrative foundation is chartered by a national coalition of organizations serving to promote community reinvestment initiatives.

According to another preferred embodiment of the invention, the step of applying the death benefits further includes applying a third portion of the policy benefits to a beneficiary designated by the selected affiliate.

According to another preferred embodiment of the invention, the third portion of the policy benefits is less than 25% of the total benefit.

According to another preferred embodiment of the invention, the step of applying the death benefits includes applying greater than 50% of the policy benefits to repay the funds loaned to the foundation.

According to another preferred embodiment of the invention, the step of applying the death benefits includes applying less than 50% of the policy benefits to the foundation to fund designated CRA initiatives.

According to another preferred embodiment of the invention, the step of applying the death benefits includes applying greater than 75% of the policy benefits to the foundation to fund designated CRA initiatives after the loan to the foundation is satisfied.

In another embodiment, the invention is method for funding initiatives under the Community Reinvestment Act (CRA) which includes the step of borrowing funds from a lending institution to purchase life insurance policies for selected affiliates of an administrative foundation. The foundation serves to promote financial opportunities and services to targeted neighborhood communities. The loan from the lending institution is collateralized using a cash value of the life insurance policies purchased by the foundation. Upon receipt of death benefits from the policies, a first portion of the policy benefits is applied to repay the funds borrowed from the lending institution, and a second portion of the policy benefits is applied to the foundation to fund designated CRA initiatives.

### BRIEF DESCRIPTION OF THE DRAWING

Some of the objects of the invention have been set forth above. Other objects and advantages of the invention will appear as the description proceeds when taken in conjunction with the attached flow diagram illustrating operation of the present method according to one preferred embodiment of the invention.

### DESCRIPTION OF THE PREFERRED EMBODIMENT AND BEST MODE

A method according to the present invention for funding initiatives under the Community Reinvestment Act (CRA) is illustrated in the flow diagram. The method operates through an administrative foundation, such as that chartered by the NCRC, to direct the flow of private capital into traditionally underserved communities. The foundation is responsible for developing and administering community reinvestment efforts in targeted neighborhoods. The present method, described below, serves to promote community reinvestment initiatives through long-term, predictable funding with minimal credit risk to the participating financial institution.

Referring to the flow diagram, a participating bank 10 subject to testing under the CRA provides a loan to the administrative foundation 20 in an amount of $75 million, for example. The bank 10 receives CRA credit for the loan under both the lending and investment tests. The loan covenants stipulate that the foundation 20 use the money to fund the premiums on a pool Variable Universal Life (VUL) policies issued by one or more highly-rated domestic life companies 30. The policies are issued on the lives of 600 selected affiliates of the foundation 20. An “affiliate” of the foundation may be any member or non-member individual who designates the bank and/or foundation as a beneficiary of its policy. In the present example, each policy requires a single premium payment of $125,000, and has a face amount of $350,000.

As collateral for the loan, the cash value of the policies is assigned to the bank 10. Policy sub-accounts are invested in bank-directed financial instruments which are segregated and not subject to insurance company creditors. To repay the loan, the bank 10 is designated as a beneficiary under each policy and receives a portion of the death benefit at policy maturity. The insured affiliate may also elect to designate (at no cost) its own beneficiary for a small portion of the benefit-less than 10%, typically. Thus, as CRA advocates, the insured affiliate may elect to leave a legacy for positive community development.

Upon death of an insured affiliate, in the example provided, 70% of the benefit is paid directly to the bank 10 and applied to the principal and accrued interest on the loan to the foundation 20. The remaining 30% of the benefit is paid to the foundation 20 and the insured affiliate's beneficiary. The benefit paid to the foundation 20 is used to fund CRA initiatives, such as loans, investments, grants, and other financial services to low- and moderate-income neighborhoods. Upon repayment of the bank loan, 75% or more of the death benefit may be paid directly to the foundation 20 and applied to community reinvestment concerns.

A method for funding initiatives under the Community Reinvestment Act is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A method for funding initiatives under the Community Reinvestment Act (CRA), comprising the steps of:
(a) lending funds to an administrative foundation serving to promote financial opportunities and services to targeted neighborhood communities, the funds being used to purchase life insurance policies for selected affiliates of the foundation;
(b) collateralizing the loan to the foundation using a cash value of the life insurance policies purchased by the foundation; and
(c) upon receipt of death benefits from the policies, applying a first portion of the benefits to repay the funds loaned to the foundation and a second portion of the benefits to the foundation to fund designated CRA initiatives.

2. A method according to claim 1, wherein the administrative foundation is chartered by a national coalition of organizations serving to promote community reinvestment initiatives.

3. A method according to claim 1, wherein the step of applying the death benefits further comprises applying a third portion of the policy benefits to a beneficiary designated by the selected affiliate.

4. A method according to claim 3, wherein the third portion of the policy benefits comprises less than 25% of the total benefit.

5. A method according to claim 1, wherein the step of applying the death benefits comprises applying greater than 50% of the policy benefits to repay the funds loaned to the foundation.

6. A method according to claim 1, wherein the step of applying the death benefits comprises applying less than 50% of the policy benefits to the foundation to fund designated CRA initiatives.

7. A method according to claim 1, wherein the step of applying the death benefits comprises, after the loan to the foundation is satisfied, applying greater than 75% of the policy benefits to the foundation to fund designated CRA initiatives.

8. A method for funding initiatives under the Community Reinvestment Act (CRA), comprising the steps of:
(a) lending funds to an administrative foundation serving to promote financial opportunities and services to targeted neighborhood communities, the funds being used to purchase life insurance policies for selected affiliates of the foundation;
(b) collateralizing the loan to the foundation using a cash value of the life insurance policies purchased by the foundation; and
(c) upon receipt of death benefits from the policies:
(i) applying a first portion of the policy benefits to repay the funds loaned to the foundation, the first portion comprising greater than 50% of the total policy benefits;
(ii) applying a second portion of the policy benefits to the foundation to fund designated CRA initiatives, the second portion comprising less than 50% of the total policy benefits; and
(iii) applying a third portion of the policy benefits to a beneficiary designated by the selected affiliate, the third portion comprising less than 25% of the total policy benefits.

9. A method according to claim 8, wherein the step of applying the death benefits comprises, after the loan to the foundation is satisfied, applying greater than 75% of the policy benefits to the foundation to fund designated CRA initiatives.

10. A method for funding initiatives under the Community Reinvestment Act (CRA), comprising the steps of:
(a) borrowing funds from a lending institution to purchase life insurance policies for selected affiliates of an administrative foundation serving to promote financial opportunities and services to targeted neighborhood communities;
(b) collateralizing the loan from the lending institution using a cash value of the life insurance policies purchased by the foundation; and
(c) upon receipt of death benefits from the policies, applying a first portion of the policy benefits to repay the funds borrowed from the lending institution and a second portion of the policy benefits to the foundation to fund designated CRA initiatives.

11. A method according to claim 10, wherein the administrative foundation is chartered by a national coalition of organizations serving to promote community reinvestment initiatives.

12. A method according to claim 10, wherein the step of applying the death benefits further comprises applying a third portion of the policy benefits to a beneficiary designated by the selected affiliate.

13. A method according to claim 12, wherein the third portion of the policy benefits comprises less than 25% of the total benefit.

14. A method according to claim 10, wherein the step of applying the death benefits comprises applying greater than 50% of the policy benefits to the lending institution to repay the funds loaned to the foundation.

15. A method according to claim 10, wherein the step of applying the death benefits comprises applying less than 50% of the policy benefits to the foundation to fund designated CRA initiatives.

16. A method according to claim 10, wherein the step of applying the death benefits comprises, after the loan to the foundation is satisfied, applying greater than 75% of the policy benefits to the foundation to fund designated CRA initiatives.

17. A method for funding initiatives under the Community Reinvestment Act (CRA), comprising the steps of:
(a) borrowing funds from a lending institution to purchase life insurance policies for selected affiliates of an administrative foundation serving to promote financial opportunities and services to targeted neighborhood communities;
(b) collateralizing the loan from the lending institution using a cash value of the life insurance policies purchased by the foundation; and
(c) upon receipt of death benefits from the policies:
(i) applying a first portion of the policy benefits to repay the funds loaned to the foundation, the first portion comprising greater than 50% of the total policy benefits;
(ii) applying a second portion of the policy benefits to the foundation to fund designated CRA initiatives, the second portion comprising less than 50% of the total policy benefits; and
(iii) applying a third portion of the policy benefits to a beneficiary designated by the selected affiliate, the third portion comprising less than 25% of the total policy benefits.

18. A method according to claim 17, wherein the step of applying the death benefits comprises, after the loan to the foundation is satisfied, applying greater than 75% of the policy benefits to the foundation to fund designated CRA initiatives.
